(19) United States
(12) Patent Application Publication
(10) Pub. No.: US 2015/0149353 A1
(43) Pub. Date: May 28, 2015

(54) METHODS AND SYSTEMS FOR OBTAINING MERCHANT IDENTIFICATION WITHIN PAYMENT AUTHORIZATION NETWORKS

(71) Applicant: Facebook, Inc., Menlo Park, CA (US)

(72) Inventors: Lee Charles Linden, San Francisco, CA (US); Neville S. Bowers, San Francisco, CA (US); Ted Edward E. Zagat, Menlo Park, CA (US)

(73) Assignee: Facebook, Inc., Menlo Park, CA (US)

(21) Appl. No.: 14/092,654

(22) Filed: Nov. 27, 2013

(51) Int. Cl. G06Q 20/28; G06Q 20/40

(52) U.S. Cl. CPC G06Q 20/28; G06Q 20/40
USPC 705/41; 705/44

(57) ABSTRACT

Exemplary methods and systems for enabling a multi-merchant gift card program are disclosed. In particular, the present application details exemplary methods and systems for obtaining merchant identification information associated with a merchant. Upon obtaining the merchant identification for a merchant, the present application further details exemplary methods and systems for enabling a gift card services for the merchant.

### BACKGROUND OF THE INVENTION

1. The Field of the Invention

One or more embodiments of the present invention relate generally to providing a gift card program for a variety of merchants. More specifically, one or more embodiments of the present invention relate to systems and methods of obtaining merchant identification information for one or more merchants to enable a gift card program for the one or more merchants.

2. Background and Relevant Art

Advances in electronic communications technologies have interconnected people and allowed for better distribution of information than ever before. To illustrate, personal computers, handheld devices, mobile phones, and other electronic access devices are increasingly being used to communicate and share information with other users. In particular, the advent of social-networking systems and services allow users to connect, communicate, or share information and content (e.g., video, audio, photographs, and/or multimedia).

These advances in electronic communications technologies have also facilitated financial transactions. In particular, electronic payment networks (e.g., electronic credit card networks) may facilitate the nearly instantaneous authorization of purchases made by users with payment cards (e.g., credit cards and/or a gift cards). Gift cards have become increasingly popular over the past decade, with annual gift card purchases accounting for tens of billions of dollars in transactions annually.

Gift cards may operate in a manner similar to traditional credit cards. In particular, gift cards may be plastic cards with a barcode or magnetic strip that may be read by an electronic credit card machine. In addition, gift card purchases may be authorized using one or more established bank or credit card networks (e.g., the Visa/Mastercard™ network, the Discover™ network, the American Express™ network, etc.).

A number of disadvantages exist with respect to conventional gift card systems. For example, gift card management is typically rigid and fails to dynamically account for a user's or a merchant's needs. On the user side, conventional gift cards lack convenient user management features, such as providing a convenient and efficient way to view gift card balances or add money to an existing gift card balance. In addition, gifting money to other people with a gift card often involves the user having to physically visit a store location to purchase the gift card.

From the merchant side, conventional gift card systems may be prohibitively expensive. For example, to offer a gift card program, a merchant typically has to have a compatible point of sale (POS) system, which brings additional administration and equipment expense. Due to the expense of a gift card system, many smaller businesses cannot afford the benefits of providing gift cards to their customers. In addition, conventional gift card systems are rigid. For example, location-based promotional efforts, product-based efforts, and other additional granularity type features are typically unavailable with a conventional gift card system.

Accordingly, there are a number of considerations to be made in improving the convenience, access, and systems associated with gift cards.

### BRIEF SUMMARY OF THE INVENTION

Embodiments of the present invention provide benefits and/or solve one or more of the foregoing or other problems in the art with methods and systems for providing a gift card program. For example, the principles described herein provide methods and systems to locate and identify merchants to enable a multi-merchant gift card program. In particular, methods and systems are disclosed to obtain a merchant identifier for a merchant within a credit card network. Upon obtaining the merchant identifier, the merchant can be included in the gift card program. As many merchants for which a merchant identifier can be obtained may be included in one or more gift card programs. For example, the gift card program can facilitate gift card transactions initiated by a user at multiple different merchants using the same gift card and/or the same gift card account number. In one example embodiment, the gift card program is offered by or through a social-networking system that provides additional advantages as will be described in more detail below.

Additional features and advantages of the present invention will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary merchant identification system according to principles described herein;

FIG. 2 illustrates an exemplary implementation of the system of FIG. 1 according to principles described herein;

FIG. 3 illustrates another exemplary implementation of the system of FIG. 1 according to principles described herein;

FIGS. 4A-4B illustrate a sequence-flow diagram illustrating interactions between the social-networking system, the credit card network, and the merchant system of FIG. 3 in accordance with one or more embodiments of the present invention;

FIG. 5 illustrates an exemplary method of obtaining an identifier assigned to a merchant according to principles described herein;

FIG. 6 illustrates another exemplary method of obtaining an identifier assigned to a merchant according to principles described herein;

FIG. 7 illustrates a further exemplary method of obtaining an identifier assigned to a merchant according to principles described herein;

FIG. 8 illustrates a block diagram of an exemplary computing device according to principles described herein; and

FIG. 9 illustrates an example network environment of a social-networking system according to principles described herein.

### DETAILED DESCRIPTION

Embodiments of the present invention provide benefits and/or solve one or more of the foregoing or other problems in the art with methods and systems for providing a gift card program. For example, the principles described herein provide methods and systems to locate and identify merchants to enable a multi-merchant gift card program. In particular, methods and systems are disclosed to obtain merchant identification information for a merchant within a credit card network. Specifically, the principles described herein provide methods and systems for obtaining a merchant identifier for a particular merchant and/or a particular merchant location. A particular merchant location can be, for example, a specific physical location (e.g., a specific brick and mortar physical address). In addition, a particular merchant location can also represent a specific e-commerce source (e.g., a website where the merchant's products and/or services may be purchased). Upon obtaining the merchant identifier, the merchant can be included in the gift card program. As many merchants for which a merchant identifier can be obtained may be included in the gift card program. For example, the gift card program can facilitate gift card transactions initiated by a user at multiple different merchants using the same gift card. In one example embodiment, the gift card program is offered by or through a social-networking system.

Although this disclosure discusses obtaining merchant identification information with respect to enabling a multi-merchant gift card program, it should be understood that the principles, systems, and methods for obtaining merchant identification information may also be effectively used to enable other types of transactional programs. For example, the principles described may be used for loyalty programs, business expense allowances, special offers, or any other transactional program. In particular, any transactional program in which there is a need or desire to have a customized transactional implication for a specific merchant can effectively use the principles, systems, and methods disclosed herein to create a customized transactional program.

A multi-merchant gift card program has several advantages over conventional gift card systems for both users and merchants. For users, a multi-merchant gift card program provides users the convenience of using a single gift card at multiple different merchants. In particular, a multi-merchant gift card can have multiple balances associated with multiple merchants, which allows a user to manage the user's gift card balances at several merchants within a single gift card program. In other words, each gift card may be capable of storing a plurality of values, with each value associated with one of a plurality of different merchants. In particular, each stored value may be redeemable only at a particular merchant or group (e.g., chain) of merchants. To illustrate, a particular gift card may include a 1st stored value associated with and redeemable at Merchant A, a 2nd stored value associated with and redeemable at Merchant B, and a 3rd stored value associated with and redeemable at Merchant C. As one will appreciate, the present invention may involve a gift card storing any number of values associated with any suitable number of merchants. Additional features of gifting and/or gift card programs are described in U.S. patent application Ser. Nos. 13/615,289; 13/615,307; 13/615,321; 13/615,328; 13/735,982; 13/835,541; and 13/835,269. The entire content of each of the foregoing applications is hereby incorporated by reference in its entirety.

Moreover, a multi-merchant gift card program provides users with the ability to easily gift amounts to others at multiple merchants with a single gift card. Each gift card may be tied to a particular user account of a user to which the gift card is issued. In particular, the user may set up an account associated with the gift card to facilitate the management of the gift card. For example, a number of different donors may give gifts to a user on the user's gift card. In particular, the multi-merchant gift card program can consolidate the values of all the gifts that the user receives for each specific merchant and make the values available for use by the user at the corresponding merchants. In some examples, the gifts stored on a gift card may originate by way of a social-networking system. In particular, a user's social-networking connections (e.g., “friends”) may give gifts to the user to be stored on the user's gift card. As such, the multi-merchant gift card program may be linked to and/or implemented within a social networking system, as already mentioned above.

As with users, a multi-merchant gift card provides merchants with several advantages compared to conventional gift card programs. For example, and as will become apparent based on this disclosure, merchants that normally would not offer a gift card program can easily participate in a multi-merchant gift card program. Moreover, a multi-merchant gift card program can provide granularity down to specific merchant locations. Thus, merchants can have granular controls on promotions by specifying specific store locations, specific products or services, and/or specific time periods for a promotion associated with the gift card program. When the multi-merchant gift card is offered by or through a social-networking system, merchants can tie rewards of social-network behavior of users (e.g., “likes,” “check-ins,” etc.) directly to the gift card of the users. Many additional benefits and features are possible. As mentioned above, although the present invention is explained with particular reference to gift cards, one will appreciate that the principles described herein are equally applicable to processing authorization requests for other types of transactions.

As briefly mentioned above, one method of providing a multi-merchant gift card program includes obtaining a unique merchant identifier assigned to the merchant within any type of transactional network. A transactional network is a communication network that facilitates a transaction between a merchant and a consumer at least partially using the communication network. One example of a transactional network is a credit card network. For example, every merchant authorized to accept credit cards is assigned a merchant identifier within the credit card network. Depending on the particular credit card network, the merchant identifier may have various labels, but generally, the merchant identifier is known as a Merchant ID, or a “MID.” For purposes of this application, the term MID is used to reference any type of unique identifier used to identify a merchant within a transactional network. For example, each credit card network has a unique MID assigned to a given merchant (e.g., a particular merchant would have a unique MID from VISA, MASTERCARD, DISCOVER, and AMERICAN EXPRESS). Generally the MID is a combination of numbers, however, the MID can be any combination of characters (e.g., numbers, letters, and/or other data) that identify the merchant within the credit card network.

In some cases, a single merchant entity having multiple locations can have a single MID that each of the multiple locations shares. However, in other cases, a single merchant entity having multiple locations will have a MID assigned to each location. In yet another case, a single merchant entity having multiple locations can be associated with several MIDs, and one or more of the multiple locations can be assigned to each one of the several MIDs associated to the merchant entity. For example, a single merchant entity may be associated with three MIDs, and each of the merchant's multiple locations can be assigned to one of the three MIDs.

To provide a multi-merchant gift card program, example embodiments of methods and systems for obtaining the MID assigned to a particular merchant and merchant location, and enabling gifting through a gift card program to the merchant are described in detail below.

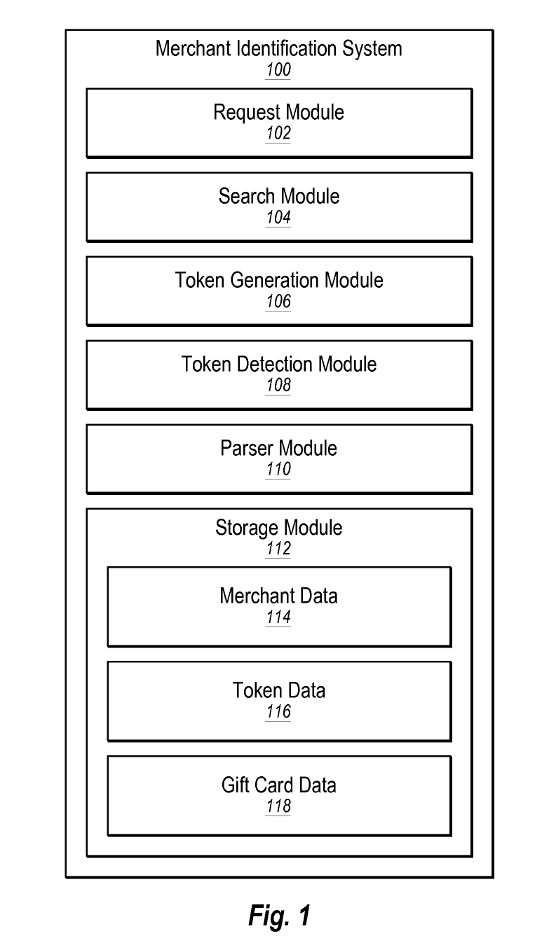

FIG. 1 illustrates an exemplary merchant identification system 100 (or simply “system 100”). System 100 may be associated with an issuer of gift cards and can be configured to obtain a MID associated with a particular merchant in order to enable gift card services for the particular merchant. In one or more embodiments, system 100 may be linked to and/or provided by way of a social-networking system (e.g., FACEBOOK™). In particular, a social-networking system may issue one or more gift cards (e.g., physical gift cards or virtual gift cards) to users of the social-networking system.

Physical gift cards may be plastic cards with a barcode or magnetic strip that may be read by an electronic credit card machine. The barcode or magnetic strip stores gift card account information, such as account number, account holder name, etc. A virtual gift card, on the other hand, may be electronic information that can be stored on any electronic device. The electronic information can include the virtual gift card information, such as account number, account holder name, etc. Both physical gift cards and virtual gift cards can be used at both physical (e.g., brick and mortar) locations, as well as e-commerce (e.g., websites) locations. For example, a user may enter the account number associated with the physical card on an e-commerce website, as well as swipe the card or cause the account number printed on the physical card to be entered into a merchant POS system at a physical location. In addition, a user may use a virtual gift card on an e-commerce website by providing the account information to the e-commerce website, for example by logging into the social-networking system. In addition, the user may have the virtual gift card information stored on a portable electronic device (e.g., smart phone) that can display information (e.g., a bar code or account number) that can be entered into the merchant POS system at a physical location. In general, both physical gift cards and virtual gift cards can be used in similar ways, however, virtual gift cards have an advantage in that a virtual gift card can be created and sent to a user almost instantaneously for use by the user.

In addition to issuing gift cards, the social-networking system can facilitate gifting among users of the social-networking system, manage values stored on the issued gift cards, manage transactions associated with the issued gift cards, and/or perform one or more steps associated gift card services. However, providing gift card services for a merchant may be implemented by the gift card service provider obtaining unique identification information for the merchant (specifically the MID associated with the particular merchant). Accordingly, system 100 may be configured to obtain information associated with merchants in order to enable gift card services for the merchants.

In particular, system 100 may obtain a MID assigned to a particular merchant in order to enable gift card services for the particular merchant. As will be described in more detail below, system 100 may be configured to obtain the MID using any of one or more methods and may enhance the efficiency of obtaining the MID for the merchant and enabling gift card services for the merchant. As an example, using the MID obtained by system 100, a social networking system that provides gift card services to its users can allow users of the social networking system to give, receive, and use gifts redeemable at the merchant. In one or more embodiments, system 100 may be implemented by and/or integrated within a social networking system that provides gift card services to its users.

As shown in FIG. 1, system 100 may include, but is not limited to, a request module 102, a search module 104, a token generation module 106, a token detection module 108, a parser module 110, and a storage module 112, each of which may be in communication with one another using any suitable communication technologies. It will be recognized that although modules 102-112 are shown to be separate in FIG. 1, any of modules 102-112 may be combined into fewer modules, such as into a single module, or divided into more modules as may serve a particular embodiment.

As will be described in more detail below, each of the modules 102-112 can be used alone and/or in combination with the other modules to determine or otherwise obtain the MID for a particular merchant and use the obtained MID to enable gift card services for the particular merchant. In particular, the modules 102-112 can be configured to execute a sequence of steps to obtain the MID from one or more sources. The order of the steps may vary from one embodiment to the next, but generally, the modules 102-112 are configured to obtain the MID in an order that provides the fastest and most reliable results. For example, the system 100 can be configured to obtain the MID from any one or more of the following sources in any order, for example: directly from the merchant; from a credit card network database; or from a payment authorization request. In alternative embodiments, the order in which to obtain the MID, as well as the sources from which to obtain the MID, may vary depending on the particular embodiment.

As will be explained in more detail below, the request module 102 can be configured to request the MID directly from the merchant. For example, the system 100 may offer a merchant an opportunity to participate in a gift card program. In one embodiment, the merchant can be offered an opportunity to participate in a gift card program through the merchant's page on a social networking system. Although not required, the social networking system can check to see if the merchant's page meets a minimum level of confidence that the page is authentic prior to offering the merchant an opportunity to participate in a gift card program. Upon receiving acceptance of the offer from the merchant, the system 100 may execute a setup process to obtain necessary information from the merchant to establish the merchant as a participant in the gift card program. For example, the system 100 may prompt the merchant to provide a list of store locations and/or other relevant information.

As part of a setup process, the request module 102 may prompt the merchant to provide the MID associated with the merchant. For example, the setup process can be facilitated through the merchant's social-networking profile (e.g., the merchant's Facebook™ page). If the merchant's social-networking profile has not yet been authenticated, then prior to asking for the MID through the merchant's social-networking profile, the social network system may optionally perform a merchant authentication process to determine at least a minimum confidence threshold is satisfied as to the authenticity of the merchant's social-networking profile. Upon determining that the minimum confidence threshold is satisfied, the social network system can proceed to request and accept MID information through the merchant's social-networking profile page.

In the event that the merchant has more than one location, the request module 102 may prompt the merchant to provide a MID associated with each store location. For example, if the merchant has four locations, the request module 102 may prompt the merchant to enter the MID for each of the four locations. If the merchant has a single location, the request module 102 may prompt the merchant to enter the MID for the single location. Upon the merchant providing the MID(s), the request module 102 can associate each merchant location with its respective MID. The request module 102 can send the MID(s) and the associated merchant information to the storage module 112 for further use by the system 100 and/or by a social-networking system, as will be explained further below.

Often the merchant will not know the MID associated with the merchant location. For example, the MID is typically only used by the credit card network to process payment authorization requests, and the merchant may not have an occasion or need to obtain the MID assigned to itself. If the MID is unknown to the merchant, then the request module 102 can provide a selectable option (e.g., on a social-networking profile page for the merchant, or on a webpage configured to facilitate the setup process) for the merchant to indicate that the MID is unknown. Upon receiving an indication that the merchant does not know the MID, the system 100 can execute additional steps to obtain the MID.

For example, and as will be described in more detail below, the search module 104 may be configured to search relevant databases or otherwise request the MID on behalf of the merchant from various sources. In general, the search module 104 is configured to communicate with the credit card network to obtain the MID assigned to the merchant.

For example, the search module 104 can communicate directly with the credit card network to access a merchant information database. The merchant information database can be accessed through an API of the credit card network, or through a data transfer from the credit card network. The merchant information database can be maintained, updated, and controlled by a provider of the credit card network. In addition, or in alternative embodiments, the merchant information database can be maintained within the storage module 112, or in any another location that serves a particular implementation.

The merchant information database may contain various types of merchant information. For example, the merchant information database can store a merchant information table mapping merchants to corresponding merchant information. In particular, the table can include multiple columns, with each column storing a particular category of information (e.g., a column for the merchant name, a column for the MID, a column for the merchant location (e.g., address), a column for the merchant phone number, a column for the merchant's type of business, and/or any additional columns including additional information associated with each merchant contained within the merchant information database).

Using known merchant information (e.g., merchant name, merchant location) the search module 104 can facilitate a search of the merchant information database for a listing of the known merchant information. For example, the known merchant information may be obtained from business listings, from a social-networking system merchant database, or other similar databases. In another embodiment, the known merchant information is obtained directly from the merchant. For example, and as described above, the merchant may be offered, through system 100, an opportunity to participate in the gift card program. Upon accepting the opportunity to participate in the gift card program, the merchant may be prompted for, and subsequently provide, identification information that is sent to the search module 104 for use in the search of the merchant information database.

Upon finding a listing for the searched merchant within the merchant information database, the search module 104 can be configured to lookup and extract the MID associated with the merchant. For example, the search module 104 can extract the MID associated with the merchant and associate the MID with the merchant. The search module 104 can send the MID and the associated merchant information to storage module 112 for further use by system 100.

Although the various credit card networks maintain the MID data and use the MID as part of processing a payment authorization request, often the credit card network providers do not know which MID is associated with the merchant's particular physical location. Therefore, and as will be discussed in detail below, the system 100 can use additional methods and systems to obtain the MID for a particular merchant.

In one embodiment, if the system 100 is unable to obtain the MID using the request module 102 or the search module 104, the system 100 can arrange to receive a message from the merchant that includes the MID. For example, one type of message that can be received from the merchant is a payment authorization request from which system 100 can obtain the MID, or which may be accompanied by the MID. As used herein, a payment authorization request is a request sent from a merchant system (e.g., a point of sale (POS) system) to a credit card network requesting a payment authorization. The payment authorization request may then be forwarded to a provider of the corresponding payment card (e.g., a buyer's card issuing bank) for approval of a transaction. The merchant may initiate a payment authorization request by swiping a user's credit card or gift card with a card reader. Alternatively, a payment authorization request can be initiated by keying-in an account number (e.g., sixteen digit number) and payment amount into a merchant POS system. Additional methods of initiating a payment authorization request may be used.

The payment authorization request can comprise various pieces of information. For example, the payment authorization request may include, in addition to other information, an account number to be charged, a payment amount to be authorized, a soft descriptor (e.g., merchant name, city, zip code), and a MID. Due to the fact that the payment authorization request includes the MID, the system 100 can use a payment authorization request sent from a known merchant to obtain the MID assigned to the merchant.

For example, and as an overview, a token generation module 106 can generate and associate a token with a merchant. Furthermore, the token generation module 106 can arrange for a payment authorization request containing the token to be sent from the merchant system to the system 100. A token detection module 108 can be configured to detect the token in the payment authorization request. Upon detection of the token, a parser module 110 can parse the information contained in the payment authorization request to extract the merchant's MID. Additional details of the token generation module 106, the token detection module 108 and the parser module 110 will be explained in further detail below.

As briefly mentioned, and as shown in FIG. 1, the system 100 can include the token generation module 106. The token generation module 106 can be configured to generate one or more token(s) to associate with the merchant. As used herein, a token is an identifier associated with the merchant. In one example embodiment, the token is a data identifier configured to be part of a payment authorization request sent from the merchant system. For example, the token can be a specified value (e.g., a token payment amount) to be entered as the payment amount to be authorized within a payment authorization request. In alternative embodiments, the token can be an account number, name, or any other information that can be entered into the merchant system (e.g., POS) as part of a payment authorization request.

In the example where the token is the payment amount to be authorized, the token value can be any value; however, it may be advantageous to set the value at a low monetary value. To illustrate, for example, the token generation module 106 can create a token representing the payment amount to be authorized in the amount of $0.14 (fourteen cents). The low monetary value provides greater assurance that the token is a unique value that will not be duplicated naturally in another payment authorization request from merchants. Typically, the token generation module 106 may generate tokens having the values ranging from $0.01 to $5.00.

The token generation module 106 can be configured to generate unique payment values for each merchant for which system 100 is attempting to obtain the MID. For example, the token generation module 106 can recall or otherwise maintain a list of token values that are assigned so as not to assign a duplicate token value to more than one merchant. In addition, once the token detection module 108 detects a particular token value within a payment authorization request or after an expiration of the particular token, the token generation module 106 (as described further below) can reuse the token value with another merchant.

Alternatively, the token generator 106 can generate duplicate tokens for different merchants by associating the token value with one or more other types of known information that will be included in the payment authorization request. For example, the token generator 106 may generate tokens in combination with known merchant information (e.g., a known zip code for a merchant location, a name of the merchant, or any other suitable information that may be included in a payment authorization request), or a known account number of a gift card. To illustrate, the token generation module 106 can generate a first token having value of $0.14 for a first merchant having a zip code of 11111, as well as generate a second token having a value of $0.14 for a second merchant having a zip code of 22222. The token detection module 108 (discussed further below) can be configured to detect the combination of the token and zip code (e.g., within the soft descriptor portion of the payment authorization request) in order to identify the payment authorization request sent from the associated merchant. Associating the token with one or more types of other known data that is included in the payment authorization request may provide additional token values to process large quantities of merchants while providing a unique token identifier combination for each merchant.

In addition to generating a token to associate with a merchant, the token generation module 106 can associate the token with a particular gift card account. For example, the token generation module 106 can associate the token with a new gift card account associated with a recipient of a gift amount. Alternatively, the token generation module 106 can associate the token with an established gift card account.

As mentioned above, upon generating the token, the token generation module 106 can associate the token with the merchant information and/or a gift card account. For example, the token generation module 106 can associate the token with merchant information and/or gift card account information using a token database table. The token database table can include a token column, merchant name column, merchant address column, merchant zip code column, user gift card account column, and/or additional columns containing additional information that is associated with the token to allow the token detection module 108 to detect the token within a payment authorization request and process the token accordingly. The token generation module 106 can send the token and the associated information, to storage module 112 for further use by the system 100, as described below. Alternatively, the token generation module 106 can send the token and the associated information directly to the token detection module 108.

As illustrated in FIG. 1, system 100 may also include the token detection module 108. The token detection module 108 can be configured to monitor payment authorization requests sent from merchant systems. In particular, the token detection module 108 monitors payment authorization requests to identify the tokens that the token generation module 106 generated. In addition, or alternatively, the detection module 108 can be configured to detect a particular gift card account. For example, upon receiving a payment authorization request, the token detection module 108 can analyze the information contained within the payment authorization request to detect if the information contained therein includes the token. For instance, the token detection module 108 can be configured to analyze the portion of the payment authorization request that includes the payment amount to be authorized to detect a value that corresponds with the assigned token.

An analysis of the payment amount by the token detection module 108 can include identifying the payment amount to be authorized within the payment authorization request. The token detection module 108 can determine if the identified payment amount to be authorized matches a token associated with a merchant. For example, the token detection module 108 can communicate with the storage module 112 to determine if the identified payment amount to be authorized matches an associated token stored on storage module 112. Alternatively, the associated tokens can be maintained directly within the token detection module 108, or otherwise made accessible to the token detection module 108.

Once the token detection module 108 determines that a payment authorization request includes a matching token, the detection module 108 can send the payment authorization request, or the information included in the payment authorization request, to the parser module 110. As mentioned above, the system 100 can include the parser module 110, as illustrated in FIG. 1. Generally, the parser module 110 is configured to parse or otherwise analyze the additional information (e.g., information in addition to the token) contained within a payment authorization request. In particular, when analyzing the additional information the parser module 110 can identify and extract the MID contained within the additional information.

In order to identify and extract the MID contained within the payment authorization request, the parser module 110 can be configured to identify a data string with particular characteristics that match the MID. For example, the parser module 110 can identify a data string with a defined number of characters. As mentioned above, the MID can be any combination of characters (e.g., numbers, letters, and/or other data) that identify the merchant within the credit card network. Alternatively, or in addition to the defined number of characters, the parser module 110 can be configured to identify header information that is associated with the MID.

Upon identifying the MID, the parser module 110 can further be configured to extract and associate the MID with the merchant associated with the identified token. For example, the parser module 110 can facilitate extracting the MID from the payment authorization request and associating the MID with the corresponding merchant that was associated with the identified token. In addition, the parser module 110 can facilitate sending the MID and the associated merchant to the storage module 112 for further use by the system 100, as described further below.

Storage module 112 may be configured to maintain various data for use with system 100. For example, and as illustrated in FIG. 1, storage module 112 can maintain merchant data 114, including data representative of merchant information, including MIDs, etc. In addition, storage module 112 can maintain token data 116, including data representative of tokens generated and/or associated with merchant, etc. Furthermore, storage module 112 can maintain gift card data 118, including data representative of one or more gift cards, gift card stored balances, gift card associated merchants, etc. In one example, the storage module 112 can maintain a single database table that contains one or more merchant data 114 columns, token data 116 columns, gift card data 118 columns, and/or other data columns as discussed above with respect to the token database table. In another example, the storage module 112 can maintain multiple database tables, with each database containing one or more columns associated with a category of data, and mapping data entries accordingly.

Storage module 112 can receive data from various sources. For example, merchant data 114 can be gathered from third-party business listing databases, provided directly by a merchant, and/or provided by users of a social-networking system. Upon receiving data, the storage module 112 can classify, organize, arrange, consolidate, and associate data in any manner suitable for a particular implementation. For example, storage module 112 can be configured to maintain merchant data 114 in a way that classifies merchants that are available for gifting. The available gifting merchants are merchants that have been associated with a MID, and are therefore available to participate in a gift card program. The storage module 112 can maintain the available gifting merchants for use by the system 100. Furthermore, storage module 112 may be configured to maintain additional or alternative data as may serve a particular implementation.

In accordance with the foregoing principles, and as will be explained in more detail below, system 100 is configured to obtain the MID of a merchant using one or more systems or methods. In particular, system 100 is capable of obtaining the MID of a merchant by requesting the MID directly from the merchant, by searching credit card network databases, or by processing a payment authorization request to extract the MID from information within the payment authorization request. By so doing, system 100, for example, can enable a multi-merchant gift card program, that allows users to give and receive gift card amounts for the merchants having identified MIDs. System 100 also provides a number of other advantages that will be apparent to one of skill in the art based on the principles described herein.

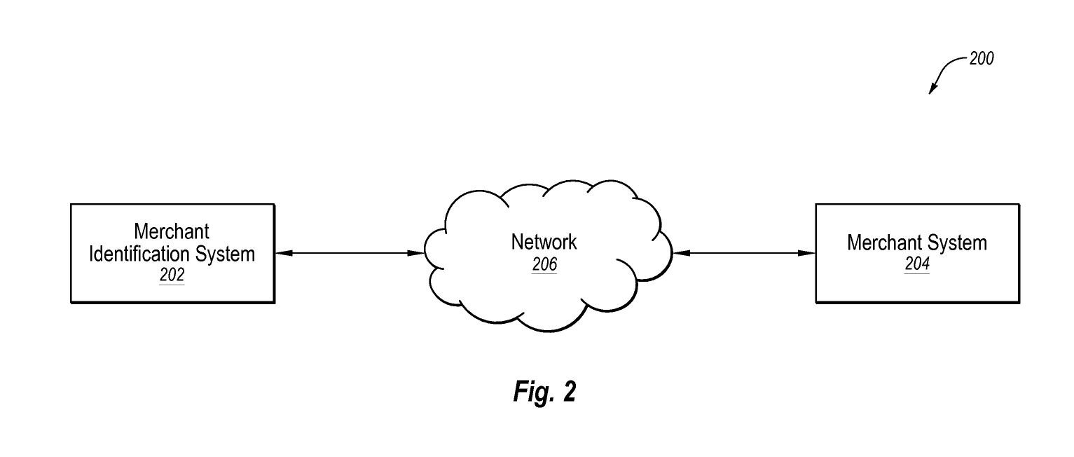

FIG. 2 illustrates an exemplary implementation 200 of system 100 wherein a merchant identification system 202 (or simply “identification system 202”) is communicatively coupled to a merchant system 204. As will be described in more detail below, request module 102, search module 104, token generation module 106, token detection module 108, parser module 110, and storage module 112 may each be implemented by the identification system 202.

Identification system 202, and merchant system 204 may communicate using any communication platforms and technologies suitable for transporting data and/or communication signals, including known communication technologies, devices, media, and protocols supportive of remote data communications, examples of which include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, wireless communication technologies, in-band and out-of-band signaling technologies, and other suitable communications networks and technologies.

In certain embodiments, identification system 202 and merchant system 204 may communicate via a network 206, which may include one or more networks, including, but not limited to, wireless networks (Wi-Fi networks), (e.g., wireless communication networks), mobile telephone networks (e.g., cellular telephone networks), closed communication networks, open communication networks, satellite networks, navigation networks, broadband networks, narrowband networks, the Internet, local area networks, and any other networks capable of carrying data and/or communications signals between identification system 202 and merchant system 204. Communications between identification system 202 and merchant system 204 may be transported using any one of the above-listed networks, or any combination or sub-combination of the above-listed networks. While FIG. 2 shows identification system 202 and merchant system 204 communicatively coupled via network 206, it will be recognized that identification system 202 and merchant system 204 may be configured to communicate one with another in any other suitable manner (e.g., via a direct connection).

In one or more embodiments, identification system 202 may be configured to obtain a MID assigned to a merchant and then use the obtained MID to enable gift services for the merchant. To illustrate, identification system 202 may be configured to maintain information for a plurality of merchants that are not identified, or in other words, merchants that have an unknown MID within the identification system 202. The identification system 202 may be configured to receive information from the merchant system 204 and process the received information to obtain the MID, and thereby associate the MID with the appropriate corresponding merchant previously having an unknown MID.

In one or more embodiments, identification system 202 may be configured to facilitate a request to the merchant to provide the MID associated with the merchant. For example, identification system 202 may prompt the merchant, by way of a social networking profile associated with the merchant, to provide the MID associated with the merchant. Similarly, the identification system 202 may be configured to facilitate the receipt of a MID from the merchant, and thereby associate the merchant with the provided MID.

In addition, identification system 202 may be configured to search a merchant information database for a MID corresponding to a merchant having an unknown MID within the identification system 202. For example, the identification system 202 can access the merchant information database located on the network 206 and search for the merchant using known merchant information. If a merchant is located within the merchant information database, the identification system 202 may be configured to extract the MID associated with the merchant and subsequently associate the MID with the merchant previously having an unknown MID within the identification system 202. Using the obtained MID, identification system 202 may enable gift card services for the merchant. For example, the obtained MID may be used to enable gifting between users of a social networking system of values redeemable at the merchant.

The identification system 202 may further be configured to generate and associate a token with a merchant having an unknown MID. The identification system 202 can be configured to arrange for the merchant system 204 to send a payment authorization request containing the token associated with the merchant to the identification system 202. For example, merchant system 204 may be associated with a particular merchant and may be configured to send payment authorization requests to identification system 202.

To illustrate, merchant system 204 may include a point-of-sale (POS) system for initiating payment authorization requests (e.g., including a card reader associated with one or more credit card networks). In response to a user using a gift card (e.g., a gift card issued by the social-networking system) at merchant system 204, merchant system 204 may send a payment authorization request to identification system 202 (e.g., by way of a credit card network, such as the Discover™ network) for processing and/or approval. Along with or within the payment authorization request, merchant system 204 may send any suitable information necessary or helpful in processing the payment authorization request. For example the payment authorization request may include and/or be accompanied with information identifying a merchant (e.g., a MID) associated with merchant system 204, information regarding the amount of the payment to be authorized, time and/or date information associated with a corresponding purchase, categorical information associated with the purchase, a geographic location of merchant system 204, and/or any other suitable information associated with the purchase.

The identification system 202 can further be configured to detect the token within the payment authorization request. Upon detecting the token within the payment authorization request, the identification system 202 can parse the payment authorization request to identify and extract the MID and associate the MID with the corresponding merchant associated with the token.

Identification system 202 may be implemented using one or more computing devices. For example, identification system 202 may be implemented using one or more server devices. Additionally merchant system 204 may each be implemented by one or more computing devices, which may include, but are not limited to, a server device, a communications device, a mobile access device (e.g., a mobile phone device, a handheld device, a laptop computer, a tablet computer, a personal-digital assistant device, etc.), a personal computer, a point-of-sale device, and/or any other device configured to perform one or more of the processes and/or operations described herein.

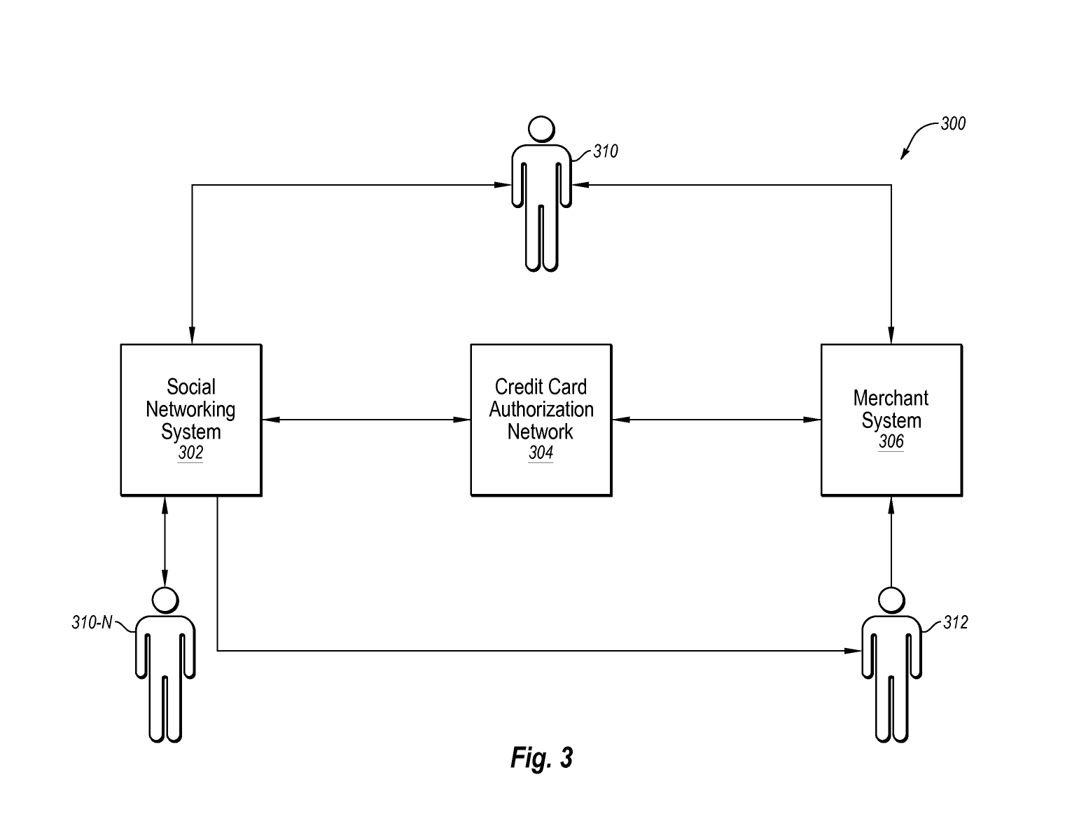

FIG. 3 shows another exemplary implementation 300 of system 100 including a social-networking system 302, a credit card network 304, and a merchant system 306 in communication by way of one or more communicational links. Implementation 300 also includes a user 310 associated with social-networking system 302, and a runner 312, each of which will be described below.

In one or more embodiments, system 100 may be implemented entirely by or within social-networking system 302. Social-networking system 302 may use one or more servers, with each of the one or more servers responsible for one or more various tasks associated with system 100. In yet additional embodiments, components of system 100 may be distributed across social-networking system 302, credit card network 304, and/or merchant system 306.

Merchant system 306 may be associated with a merchant with a physical location and/or an e-commerce merchant with an e-commerce website or native application. User 310 may choose to use the gift card to make a purchase (e.g., initiate a gift card transaction) at merchant system 306. In response to user's 310 use of a gift card (e.g., a gift card provided by, managed by, and/or otherwise associated with social networking system 302) at merchant system 306, merchant system 306 may send a payment authorization request by way of credit card network 304. Credit card network 304 may be any suitable credit card network. In some embodiments, the gift card may be designated for use specifically with credit card network 304.

Credit card network 304 may be configured to facilitate the payment authorization process and/or a corresponding settlement process. In particular, credit card network 304 may facilitate delivery of a payment authorization request from merchant system 306 to social-networking system 302 and/or facilitate receipt of a response to the payment authorization request from social-networking system 302 or social-networking system 302. Obtaining the MID from a payment authorization request by social-networking system 302 may implement one or more of the principles or features described for obtaining the MID from the payment authorization requests, such as those discussed with respect to system 100 and implementation 200.

As will be described in more detail below, request module 102, search module 104, token generation module 106, token detection module 108, parser module 110, and storage module 112 may each be implemented on the social-networking system 302. For example, and as described in detail above, the social-networking system 302 may facilitate assigning a token to the merchant and arranging to receive, from the merchant system 306, a payment authorization request that includes the token. The systems and methods for arranging for the merchant system 306 to send a payment authorization request including the token may vary from one embodiment to the next.

In one example embodiment, the social-networking system 302 may facilitate a gift card transaction at the merchant system 306, which in turn causes the merchant system 306 to send the payment authorization request. A gift card transaction can be initiated at the merchant system 306 in various ways, for example, by physically swiping a gift card, using a gift card number to initiate an ecommerce transaction, or in any other manner suitable for initiations of a gift card transaction.

In one or more embodiments, after generating and associating the token with the merchant, the social-networking system 302 can facilitate the issuing and sending of the gift card to the merchant system 306 with instructions to initiate a gift card transaction by using the gift card on the merchant system 306. Upon initiating the gift card transaction with the gift card, the merchant system 306 can send a payment authorization request that includes the token to the social-networking system 302.

Various additional or alternative steps can be used to facilitate the initiation of a gift card transaction on the merchant system. For example, and as illustrated in FIG. 3, the social-networking system 302 can facilitate issuing and sending the runner 312 a gift card with instructions to use the gift card at the merchant's physical location. In addition, the instructions can indicate an amount to be paid with the gift card, for example $0.14 (fourteen cents). As explained above, the value of the amount to be approved can be used as the token, and therefore, the $0.14 value becomes the token. Upon arriving at the merchant's physical location, the runner 312 can use the gift card to initiate a gift card transaction at the POS of the merchant for the amount instructed (e.g., $0.14).

In response to the runner 312 using the gift card to initiate a gift card transaction, the merchant system 306 can send a payment authorization request to the credit card network 304 for the amount instructed. The credit card network 304 can recognize the gift card was issued by the social-networking system 302, or that the payment authorization request is associated with a gift card program provided by the social-networking system 302, and therefore, the credit card network 304 may send the payment authorization request to the social-networking system 302. As described above, the social-networking system 302 may detect the token within the payment authorization request, parse the information within the payment authorization request, and extract the MID included in the payment authorization request and associate the extracted MID with the merchant that is associated with the token.

As explained above, the runner 312 is one method of facilitating an initiation of a gift card transaction using the gift card at the merchant system 306. In one example embodiment, the runner 312 can be an employee the company that facilitates the social-networking system. Alternatively, the runner can be a third party. For example, the runner can be a member of TaskRabbit™ or a similar type of service. To illustrate, the social-networking system 302 may be configured to send a request to the TaskRabbit™ system along with the gift card and instructions. The TaskRabbit™ system then coordinates sending the runner 312 to the physical location of the merchant to initiate the gift card transaction as explained above. Various other methods of facilitating a physical initiation of the gift card transaction at the merchant system 306 may be used to accomplish the objectives set forth above.

In addition to arranging for the gift card to be used at the merchant system 306, the social-networking system 302 can arrange for a keying a virtual transaction at the merchant system 306 (e.g., POS). For example, the social-networking system 302 may offer the merchant an opportunity to participate in the gift card program. Upon the merchant accepting the offer, the social-networking system 302 may facilitate a gift card setup process with the merchant. The setup process can be facilitated via the merchant's administration and/or profile page on the social-networking system 302.

As part of the gift card setup process, the social-networking system 302 may generate and associate a token with the merchant, as explained in detail above. In addition, the social-networking system 302 may generate and send the merchant (e.g., by way of the merchant's administration and/or profile page on the social-networking system) a gift card number and instructions to charge the gift card a value that matches the token. For example, the merchant may receive the gift card number and instructions to charge the gift card number $0.14. If the merchant has more than one location, the social-networking system 302 may generate a gift card number and a token for each location. Alternatively, the social-networking system 302 may generate only one gift card number, but may generate a unique token for each merchant location.

The merchant can use the gift card number and the instructed amount to charge to initiate a payment authorization request directly from the merchant system 306. For example, upon receiving the gift card number and the amount to charge, the merchant may use the merchant system 306 to enter the account number and the amount to charge to initiate the payment authorization request. In this way, the payment authorization request from which the MID is obtained is sent from the merchant system 306 during the setup of the merchant's gift card program on the social-networking system 302.

In addition to working directly with the merchant to setup the gift card program, example embodiments of the present invention also allow users of the social-networking system to identify merchants that the users want to participate in the gift card program. Accordingly, the present invention may leverage crowd sourcing to build a database of merchant information and/or provide gift card services. As illustrated in FIG. 3, social-networking system 302 may be configured to provide one or more social-networking services to a plurality of users 310-N (N representing any number of users greater than or equal to one). In particular, social-networking system 302 may be configured to allow user 310 to interact with one or more of the plurality of users 310-N. For example, one or more of the plurality of users 310-N can be contacts (e.g., “friends”) of user 310.

In one or more embodiments, social-networking system 302 may use information regarding the social-networking activity of user 310 and other users of social-networking system 302 to obtain the MID from the merchant. For example, social-networking system 302 may be configured to issue a gift card to user 310. The gift card has a unique account number that is associated with user 310. As stated above, the user 310 may identify a merchant that the user 310 wishes to participate in the gift card program. The user may identify the merchant on the social-networking system 302, for example by “liking” the merchant, “checking in” at the merchant, or otherwise indicating a desire that the merchant be a member of the gift card program. For example, in response to “liking” the merchant, the social-networking system 302 may send the user 310 a prompt asking if the user wants the merchant to be part of the gift card program.

Upon receiving information that the user would like the merchant added to the gift card program, social-networking system 302 can generate a token for the merchant. As described above, the social-networking system 302 can generate and associate a token with the merchant, (and/or associate the token with the users gift card number) and can then facilitate sending the user 310 instructions to initiate a gift card transaction with the user's gift card at the merchant system 306 for a particular amount that corresponds with the generated token. For example, the social-networking system 302 can send a message to the user 310 with instructions to swipe the user's gift card on the merchant system 306 for a particular amount (e.g., the token value).

As described in detail above, upon the user 310 initiating the gift card transaction with the user's gift card on the merchant system 306, the merchant system 306 can send a payment authorization request that includes the MID for the merchant. The social-networking system 302 can receive the payment authorization request, identify the token contained in the payment authorization request, parse the payment authorization request and extract the MID and associate the MID with the merchant. The merchant can then be added to the gift card program and the user 310 can send gift amounts to one or more of the users 310-N for use at the merchant.

In this way, the user-base of the social-networking system 302 can build a gift card program that matches each user's particular merchant preferences. Moreover, because the social-networking system 302 can communicate with the user 310 through a mobile device, the user can create the gift card program as the user visits various merchant locations in the normal course of the user's day.

In one example embodiment, when the user 310 is using a location enabled mobile device (e.g., a smartphone with GPS capability), the social-networking system 302 can receive location information from the user's location enabled mobile device that corresponds with a payment authorization request. For example, the user's 310 mobile device can send the social-networking system 302 location information of the user 310 (and thus the location of the merchant) with a timestamp that substantially corresponds to the time the user 310 initiates a payment authorization request at the merchant system 306. The payment authorization request can include information that indicates the time that the payment authorization request was initiated. The timestamp of the location information, and the time information within the payment authorization request, can be correlated to match a payment authorization request with a merchant associated with the location information. Thus, the time included in the payment authorization request can be used as a token, or another indicator, to distinguish the payment authorization request to be able to extract and associate the MID with the correct merchant and merchant location.

To illustrate, the social-networking system 302 can maintain an account number associated with user's 310 gift card. The social-networking system 302 can also maintain location information for user 310 sent from the user's location enabled mobile device. For example, the social-networking system 302 can implicitly collect location information by monitoring the position of the location enabled mobile device. Alternatively, the social-networking system 302 can explicitly collect location information through a “check-in” or similar process.

The social-networking system 302 can monitor the user's 310 gift card account activity and match the time information included in payment authorization requests with the user's 310 maintained location information. For example, the social-networking system 302 can monitor payment authorization requests initiated by the user's 310 gift card. Upon receiving a payment authorization request initiated with the user's 310 gift card, the social-networking system 302 can determine the time the payment authorization request was initiated based on information included in the payment authorization request. The social-networking system can then search the user's 310 timestamp location information to determine if there is a location with a timestamp that matches, or approximately matches, the time the payment authorization request was received. If there is a matching timestamp, the social-networking system 302 can proceed to extract the MID from the payment authorization request and associate the MID with the merchant and merchant location associated with the location information using principles, methods, and systems as described above.

Although the above user 310 method is described as including the step of generating a token to be used with the user's 310 gift card, in alternative embodiments the user 310 may simply swipe the user's 310 gift card at the merchant system 306 (with or without advance notice to social-networking system 302). In response to the swipe, the merchant system 306 sends a payment authorization request (e.g., the payment authorization request does not contain a token) through the credit card network 304 to the social-networking system 302. Upon receiving the payment authorization request, the social-networking system 302 can be configured to use information from the user 310 to identify and associate the payment authorization request with the merchant. Additionally or alternatively, social-networking system 302 can perform a fuzzy logic routine on the soft descriptor in the payment authorization request to determine the merchant and the MID.

In one example embodiment, social-networking system 302 parses the soft descriptor information contained in the payment authorization request and uses the fuzzy logic routine to determine a merchant name and location. For example, the social-networking system 302 may be configured to search for a merchant name and zip code in the soft descriptor. The social-networking system 302 can cross-match any identified merchant names and zip codes found in the payment authorization request to one or more business listing databases or one or more business profiles (e.g., Facebook Pages) on social networking system 302 to determine the merchant and merchant location from where the payment authorization request was sent. Alternatively, or in addition to the above, the results of the fuzzy logic routine can be compared to merchants where a user has received gifts to verify the results match a valid merchant and merchant location. Upon verifying the merchant and merchant location, the social-networking system 302 can then extract and associate the MID with the merchant as described in detail above.

The social-networking system 302 can be configured to use the fuzzy logic routine on some or all payment authorization requests in order to determine the merchant and MID associated with the payment authorization request. For example, payment authorization requests that do not include a token may be targeted for processing with the fuzzy logic routine. In addition, the social-networking system 302 can be configured to communicate with the credit card network 304 to obtain batches of payment authorization requests. The social-networking system 302 can use the fuzzy logic routine to process the batches of payment authorization requests that result in a database of identified merchants and associated MIDs.

As mentioned above, the merchants included in the database of identified merchants having associated MIDs can be made available to the users of the social-networking system 302 for gifting purposes. In particular, the MID of a merchant can be identified using one or more of the methods and systems described herein. Once the MID is identified, gifting services for the merchant are made available to user's of the social-networking system 302. To illustrate, a first user can gift a gift amount to a second user to be used at the merchant. The gift amount can be stored on the second user's multi-merchant gift card for use at the merchant. The second user can then use the gift amount at the merchant by initiating a gift card transaction at the merchant (e.g., swiping the gift card). Upon initiating the gift card transaction, the merchant system 306 can send a payment authorization request to the social-networking system 302. After the social-networking system 302 authorizes the request for the payment, and the payment can be settled using known methods in the art.

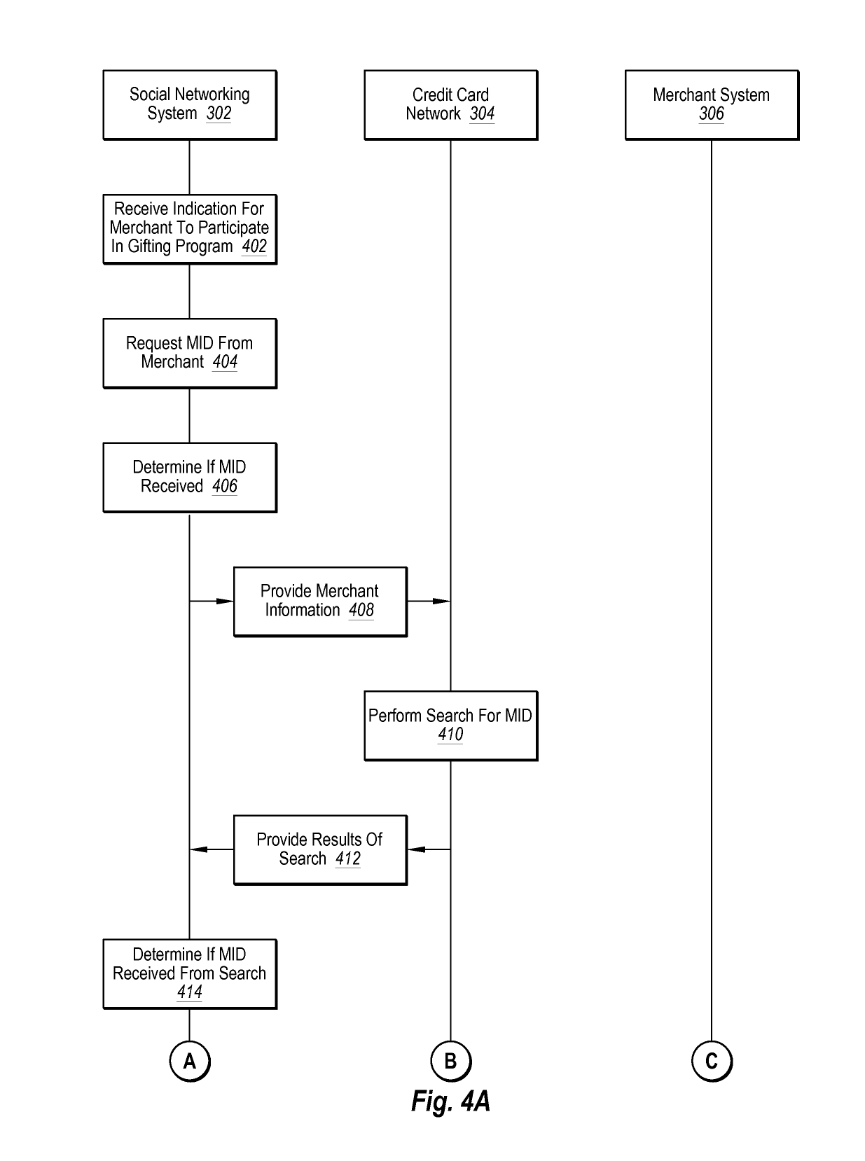

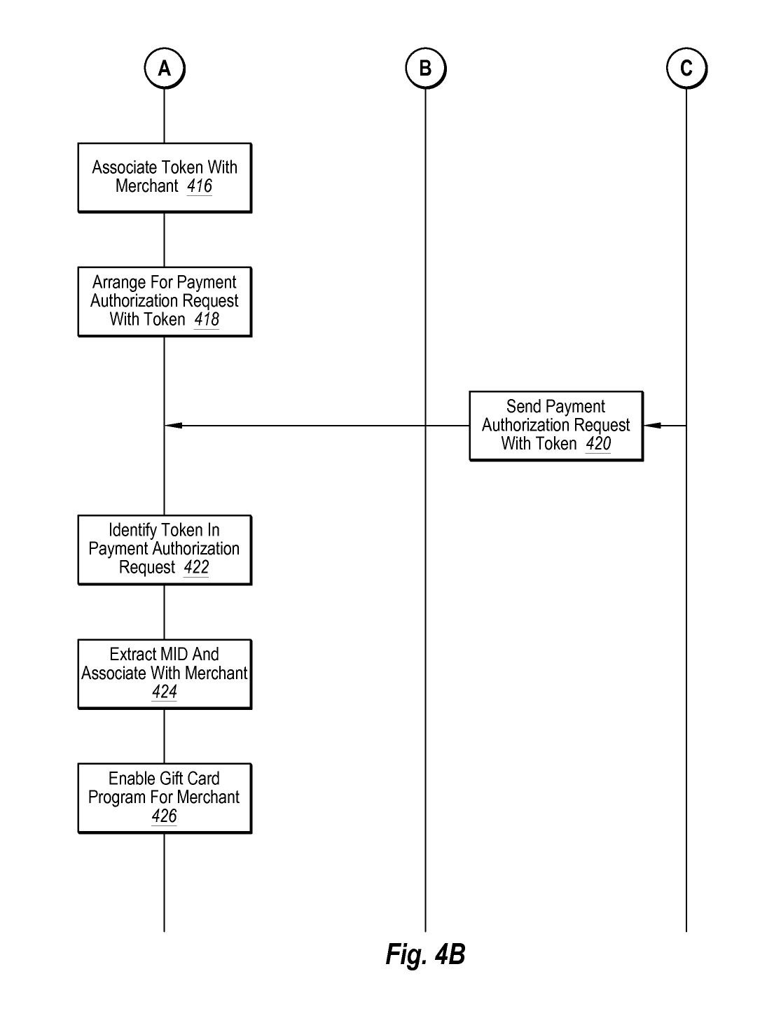

Referring now to FIGS. 4A-4B, a sequence-flow diagram illustrating an embodiment of the social-networking system 302 determining, or otherwise obtaining, a MID associated with a particular merchant is shown. The diagram of FIGS. 4A-4B illustrates one embodiment of a timeline illustrating the interactions of the social-networking system 302, the credit card network 304, and the merchant system 306 in accordance with an embodiment of the present invention.

As shown in FIG. 4A, the social-networking system 302 can receive an indication for a merchant to participate in a gifting program 402. For example, and as explained in detail above, the merchant can accept an offer to participate in a gift card program through the merchant's social-networking profile on the social-networking system 302. Alternatively, a user of the social-networking system 302 can indicate an interest in gifting through the merchant. In an alternative embodiment, the social-networking system 302 does not have to receive an indication to participate in a gifting program from a source outside the social-networking system 302, but rather, the social-networking system 302 can attempt to determine, or otherwise obtain, a MID associated with the merchant based on an indication internal to the social-networking system 302. For example, the social-networking system 302 can proceed to attempt to obtain a MID associated with the merchant based on information gathered from the social-network system 302 that a threshold number of users of the social-networking system 302 make purchases from the merchant.

After receiving an indication for the merchant to participate in a gifting program 402, the social-networking system 302 can commence a series of processes to attempt to determine or otherwise obtain the MID associated with the merchant. As shown, and as described above, one process to obtain the MID is for the social-networking system 302 to request the MID directly from the merchant 404. For example, at some point after the merchant indicates an interest to participate in a gifting program through the merchant's social-networking profile, the social-networking system 302 can prompt the merchant to provide the MID associated with the merchant through the merchant's social-networking profile. The process of requesting the MID from the merchant 404 is optional and the use of the process may depend on if the merchant requested to participate in the gifting program 402.

If the MID was requested from the merchant 404, then the social-networking system 302 can then determine if the MID was received 406. If the MID was received, then the social-networking system 302 can proceed to enabling the gift card program for the merchant 426, as shown on FIG. 4B. Alternatively, the remaining processes in the sequence-flow diagram may still be implemented in order to verify that the MID provided by the merchant is a valid MID.

If the MID was not provided by the merchant, or in order to verify the MID provided by the merchant is valid, the social-networking system 302 can initiate a search for the MID in a merchant information database. For example, and as shown in FIG. 4A, the social-networking system 302 can provide merchant information 408 (e.g., merchant name, location, etc.) to the credit card network 304. Upon receiving the merchant information, the credit card network can then use the merchant information to perform a search for the MID within the merchant information database 410, as shown. For example, the credit card network 304 can search the merchant information database for a merchant having the same or similar information as the merchant information received from the social-networking system 302, as described above.

If a matching merchant is found within the merchant information database, the credit card network 304 can then extract the MID associated with the matching merchant and provide the results of the search 412 to the social-networking system 302, as shown in FIG. 4A. Upon receiving the results of the search, the social-networking system 302 can determine if the MID was received within the search results 414. If the MID was received within the search results, then the social-networking system 302 can proceed to enable the gift card program for the merchant 426, as shown on FIG. 4B. Alternatively, or additionally, the remaining processes in the sequence-flow diagram may still be implemented in order to verify that the MID is a valid MID.

If the MID was not received within the search results, or in order to verify the MID received from the search results is valid, the social-networking system 302 can then associate a token with the merchant 416. For example, and as described in detail above, the token generation module can create and associate a token with the merchant. In one embodiment, the token can be a monetary value, or any other value that can be entered into the merchant system 306 and propagated through the credit card network 304 to the social-networking system 302.

After associating the merchant with a token, the social-networking system 302 can arrange for a payment authorization request that includes the token 418 to be sent from the merchant system 306. For example, and as discussed in further detail above, the social-networking system can directly instruct the merchant to initiate a payment authorization request containing the token through the merchant's POS system. Alternatively, the social-networking system can instruct a user of the social-networking system to initiate a payment authorization request at the merchant's POS system. Additional methods of arranging for a payment authorization request that include the token are described throughout the application.

The merchant system 306 then sends a payment authorization request with the token 420 through the credit card network 304. As explained above, because the merchant is identified on the credit card network 304 by the MID associated with the merchant, the payment authorization request includes the MID that is associated with the merchant. Therefore, when the social-networking system 302 receives the payment authorization request, the payment authorization request includes the token associated with the merchant as well as the MID.

The social-networking system 302 can identify the token included in the payment authorization request 422, as shown in FIG. 4B. For example, and as explained previously, the token can be the payment amount to be authorized. Thus, the social-networking system 302 can identify the payment amount to be authorized that matches the token value associated with the merchant. After identifying the token in the payment authorization request, the social-networking system 302 can extract the MID from the payment authorization request and associate the MID with the merchant associated with the identified token 424.

At this point, the social-networking system 302 can enable a gift card program for the merchant 426 according to the principles described or referenced herein. The diagram illustrated in FIGS. 4A-4B illustrates one embodiment in which the social-networking system 302 determines or otherwise obtains the MID through one or more sources to enable a gift card program for a merchant. The present invention, however, is not so limited. In alternative embodiments, only a portion of the diagram shown in FIGS. 4A-4B may be used to obtain the MID for the merchant. For instance, the social-networking system 302 may only use the portion of the diagrams relating to a token (e.g., those portions illustrated in FIG. 4B). Alternatively, or in addition to, procedures may be added to the sequence-flow to obtain the MID according to principles described or referenced herein.

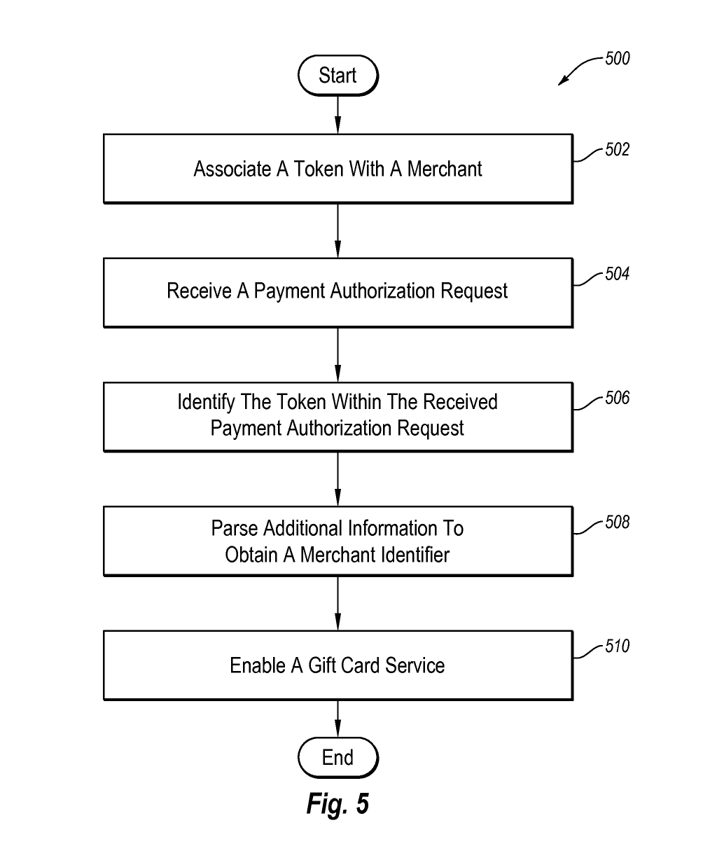

FIG. 5 illustrates an exemplary method 500 of obtaining an identifier assigned to a merchant. While FIG. 5 illustrates exemplary steps according to one embodiment, other embodiments may omit, add to, reorder, and/or modify any of the steps shown in FIG. 5. One or more of the steps shown in FIG. 5 may be performed by any component or combination of components of system 100.

Step 502 may include associating a token with a merchant. In particular, step 502 may include generating a token for the merchant, and associating the token with the merchant. For example, token generation module 106 may be configured to generate a token for the merchant, and associate the token with the merchant in any suitable manner, such as described herein. To illustrate, token generation module 106 may be configured to identify information associated with an unidentified merchant, generate a token for the unidentified merchant, and associate a generated token with the unidentified merchant.

Step 504 may include receiving a payment authorization request from the merchant. In particular, step 504 may include receiving a payment authorization request from the merchant, and wherein the payment authorization request includes the token associated with the merchant. For example, the payment authorization request may be received from a merchant in response to the use of a gift card at the merchant, or any suitable manner, such as described herein.

Step 506 may include identifying the token within the received payment authorization request. For example, token detection module 108 may be configured to detect the token in any suitable manner, such as described herein. In some examples, the token may be the payment amount to be authorized. Identifying the token may comprise determining if the payment amount to be authorized matches a value generated by the token generator module 106.

Step 508 may include parsing additional information within the received payment authorization request to obtain a merchant identifier associated with the merchant. For example, parser module 110 can be configured to parse additional information within the received payment request upon the token detection module identifying the token. To illustrate, parser module 110 may parse the payment authorization request for the MID associated with the merchant that sent the payment authorization request. In addition, the parser module 110 can locate the MID within the payment authorization request based on a particular number of characters and/or based upon header information included within the payment authorization request.

Step 510 may include enabling a gift card service using the merchant identifier. In particular, the identifier may be the MID assigned to the merchant, and step 510 may include associating the MID with the merchant within the social-networking system. Once the MID is associated with the merchant, the social-networking system can turn on gifting for the merchant.

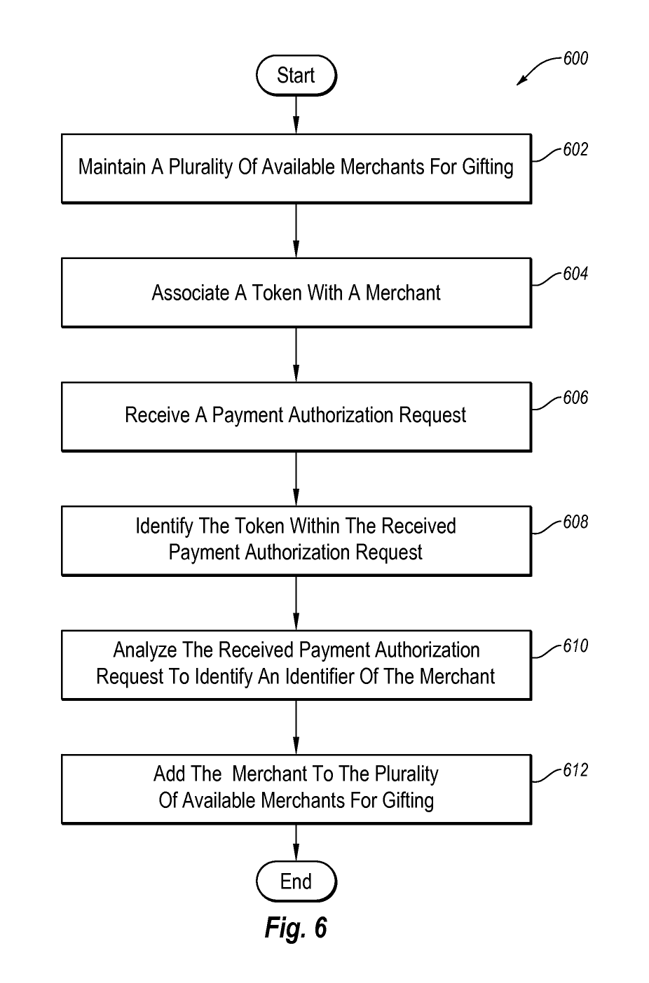

FIG. 6 illustrates another exemplary method 600 of obtaining an identifier assigned to a merchant. While FIG. 6 illustrates exemplary steps according to one embodiment, other embodiments may omit, add to, reorder, and/or modify any of the steps shown in FIG. 6. One or more of the steps shown in FIG. 6 may be performed by any component or combination of components of system 100.

Step 602 may include maintaining a plurality of available merchants for gifting. In particular, step 602 may include maintaining a database identifying a plurality of available merchants for gifting. For example, the social-networking system can maintain information associated with available merchants that allow social-networking system users to gift to one another at the available merchants. For example, storage module 112 may be configured to maintain any information associated with the available merchants for gifting, such as described herein.

Step 604 may include associating a token with a merchant. In particular, step 604 may include associating a token for a merchant not included in the plurality of available merchants for gifting. For example, token generation module 106 may be configured to generate and associate a token with the merchant in any suitable manner, such as described herein. To illustrate, token generation module 106 may be configured to receive an unidentified merchant, generate a token for the unidentified merchant, and associate the generated token with the unidentified merchant.

Step 606 may include receiving a payment authorization request. In particular, step 606 may include receiving a payment authorization request from a merchant that has been associated with the token, and wherein the payment authorization request includes the token. For example, the payment authorization request may be received from the merchant in response to the merchant entering a gift card number and amount to be authorized for payment provided to the merchant via the social-networking system, or any suitable manner, such as described herein.

Step 608 may include identifying the token within the received payment authorization request. For example, token detection module 108 may be configured to detect the token in any suitable manner, such as described herein. In some examples, the token may be the payment amount to be authorized. Identifying the token may comprise determining if the payment amount to be authorized matches a token generated by the token generator module 106.

Step 610 may include analyzing the received payment authorization request. In particular, step 610 may include analyzing the received payment authorization request to obtain an identifier of the merchant. For example, the parser module 110 can locate the identifier based on a particular number of characters or based upon header information included within the payment authorization request. To illustrate, the parser module 110 can identify the MID that is included within the payment authorization request.

Step 612 may include adding the merchant to the plurality of available merchants for gifting. In particular, parser module 100 can add the merchant to the maintained plurality of available merchants for gifting that are maintained on storage module 110.

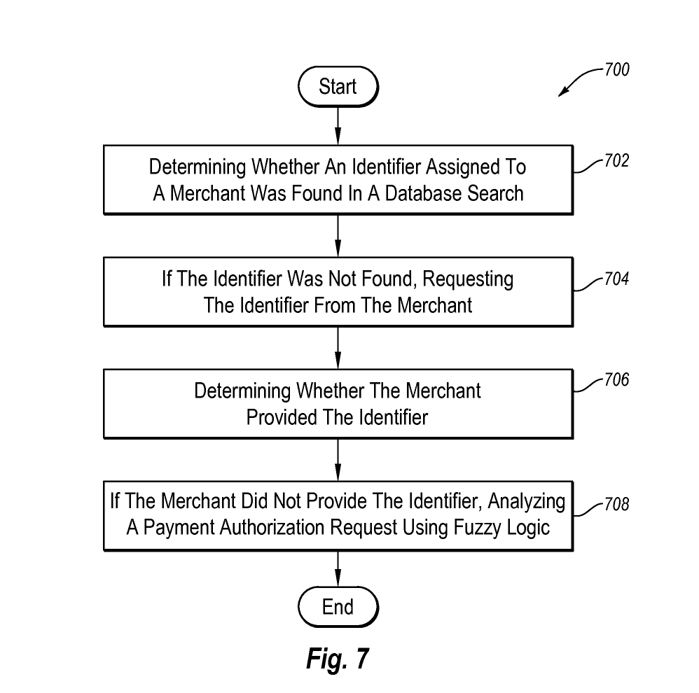

FIG. 7 illustrates a further exemplary method 700 of obtaining an identifier assigned to a merchant. While FIG. 7 illustrates exemplary steps according to one embodiment, other embodiments may omit, add to, reorder, and/or modify any of the steps shown in FIG. 7. One or more of the steps shown in FIG. 7 may be performed by any component or combination of components of system 100.

Step 702 may include determining whether an identifier assigned to a merchant was found in a database search. For example, search module 104 can confirm that the MID assigned to the merchant was found upon the credit card network returning results of a merchant information database search based on merchant information provided by the search module 104. In addition, if the identifier was found, the search module 104 can associate the merchant with the identifier in any suitable manner, such as described herein.

Step 704 may include if the identifier was not found in a database search, requesting the identifier from the merchant. For example, request module 104 can facilitate sending a request to the merchant to request the MID assigned to the merchant. To illustrate, the request module 104 may send the request to the merchant via the social-networking system.

Step 706 may include determining whether the merchant provided the identifier. For example, the request module 104 can verify if the merchant provided a response to the request. To illustrate, request module 104 can be configured to verify if the merchant provided the MID assigned to the merchant. In addition, if the merchant provided the MID assigned to the merchant, the request module 104 can be configured to associate the MID with the merchant in any suitable manner, such as disclosed herein.

Step 708 may include if the merchant did not provide the identifier, analyzing an unidentified payment authorization request using a fuzzy logic routine to obtain the merchant identifier. For example, if the merchant did not provide the identifier, step 708 can include analyzing an unidentified payment authorization request using a fuzzy logic routine to identify merchant name information and merchant location information. If a payment authorization request from the merchant is identified, the MID can be extracted from the payment authorization requested and associated with the merchant in any suitable manner, such as disclosed herein.

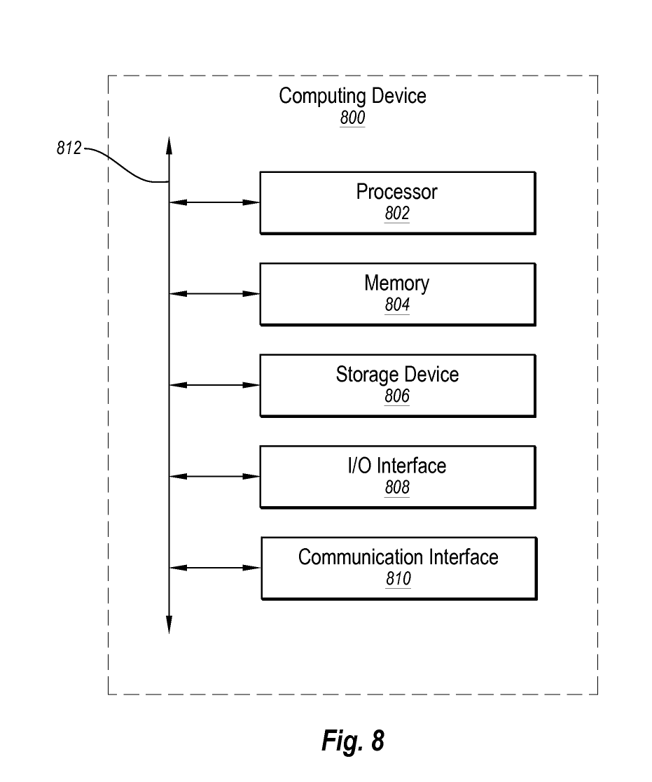

FIG. 8 illustrates, in block diagram form, an exemplary computing device 800 that may be configured to perform one or more of the processes described above. One will appreciate that system 100, identification system 202, merchant system 204, social-networking system 302, social-networking system 302, credit card network 304, and/or merchant system 306 each comprise one or more computing devices in accordance with implementations of computing device 800. As shown by FIG. 8, the computing device can comprise a processor 802, a memory 804, a storage device 806, an I/O interface 808, and a communication interface 810, which may be communicatively coupled by way of communication infrastructure 812. While an exemplary computing device 800 is shown in FIG. 8, the components illustrated in FIG. 8 are not intended to be limiting. Additional or alternative components may be used in other embodiments. Furthermore, in certain embodiments, a computing device 800 can include fewer components than those shown in FIG. 8. Components of computing device 800 shown in FIG. 8 will now be described in additional detail.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage device 806 and decode and execute them. In particular embodiments, processor 802 may include one or more internal caches for data, instructions, or addresses. As an example and not by way of limitation, processor 802 may include one or more instruction caches, one or more data caches, and one or more translation lookaside buffers (TLBs). Instructions in the instruction caches may be copies of instructions in memory 804 or storage 806.

Memory 804 may be used for storing data, metadata, and programs for execution by the processor(s). Memory 804 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 804 may be internal or distributed memory.

Storage device 806 includes storage for storing data or instructions. As an example and not by way of limitation, storage device 806 can comprise a non-transitory storage medium described above. Storage device 806 may include a hard disk drive (HDD), a floppy disk drive, flash memory, an optical disc, a magneto-optical disc, magnetic tape, or a Universal Serial Bus (USB) drive or a combination of two or more of these. Storage device 806 may include removable or non-removable (or fixed) media, where appropriate. Storage device 806 may be internal or external to the computing device 800. In particular embodiments, storage device 806 is non-volatile, solid-state memory. In other embodiments, Storage device 806 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 808 allows a user to provide input to, receive output from, and otherwise transfer data to and receive data from computing device 800. I/O interface 808 may include a mouse, a keypad or a keyboard, a touch screen, a camera, an optical scanner, network interface, modem, other known I/O devices or a combination of such I/O interfaces. I/O interface 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interface 808 is configured to provide graphical data to a display for presentation to a user. The graphical data may be representative of one or more graphical user interfaces and/or any other graphical content as may serve a particular implementation.

Communication interface 810 can include hardware, software, or both. In any event, communication interface 810 can provide one or more interfaces for communication (such as, for example, packet-based communication) between computing device 800 and one or more other computing devices or networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 810 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 810 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Communication infrastructure 812 may include hardware, software, or both that couples components of computing device 800 to each other. As an example and not by way of limitation, communication infrastructure 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, system 100 may be linked to and/or implemented within a social-networking system. A social-networking system may enable its users (such as persons or organizations) to interact with the system and with each other. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may store records of users and relationships between users in a social graph comprising a plurality of nodes and a plurality of edges connecting the nodes. The nodes may comprise a plurality of user nodes and a plurality of concept nodes. A user node of the social graph may correspond to a user of the social-networking system. A user may be an individual (human user), an entity (e.g., an enterprise, business, or third party application), or a group (e.g., of individuals or entities). A user node corresponding to a user may comprise information provided by the user and information gathered by various systems, including the social-networking system.

For example, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a profile page). In response to a request including a user name, the social-networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

A concept node may correspond to a concept of the social-networking system. For example, a concept can represent a real-world entity, such as a movie, a song, a sports team, a celebrity, a group, a restaurant, or a place or a location. An administrative user of a concept node corresponding to a concept may create or update the concept node by providing information of the concept (e.g., by filling out an online form), causing the social-networking system to associate the information with the concept node. For example and without limitation, information associated with a concept can include a name or a title, one or more images (e.g., an image of cover page of a book), a web site (e.g., an URL address) or contact information (e.g., a phone number, an email address). Each concept node of the social graph may correspond to a web page. For example, in response to a request including a name, the social-networking system can access a concept node corresponding to the name, and construct a web page including the name and other information associated with the concept.

An edge between a pair of nodes may represent a relationship between the pair of nodes. For example, an edge between two user nodes can represent a friendship between two users. For another example, the social-networking system may construct a web page (or a structured document) of a concept node (e.g., a restaurant, a celebrity), incorporating one or more selectable buttons (e.g., “like”, “check in”) in the web page. A user can access the page using a web browser hosted by the user's client device and select a selectable button, causing the client device to transmit to the social-networking system a request to create an edge between a user node of the user and a concept node of the concept, indicating a relationship between the user and the concept (e.g., the user checks in to a restaurant, or the user “likes” a celebrity).

As an example, a user may provide (or change) his or her city of residence, causing the social-networking system to create an edge between a user node corresponding to the user and a concept node corresponding to the city declared by the user as his or her city of residence. In addition, the degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.”

A social-networking system may support a variety of applications, such as photo sharing, on-line calendars and events, gaming, instant messaging, and advertising. For example, the social-networking system may also include media sharing capabilities. Also, the social-networking system may allow users to post photographs and other multimedia files to a user's profile page (typically known as “wall posts” or “timeline posts”) or in a photo album, both of which may be accessible to other users of the social-networking system depending upon the user's configured privacy settings. The social-networking system may also allow users to configure events. For example, a first user may configure an event with attributes including time and date of the event, location of the event and other users invited to the event. The invited users may receive invitations to the event and respond (such as by accepting the invitation or declining it). Furthermore, the social-networking system may allow users to maintain a personal calendar. Similarly to events, the calendar entries may include times, dates, locations and identities of other users.

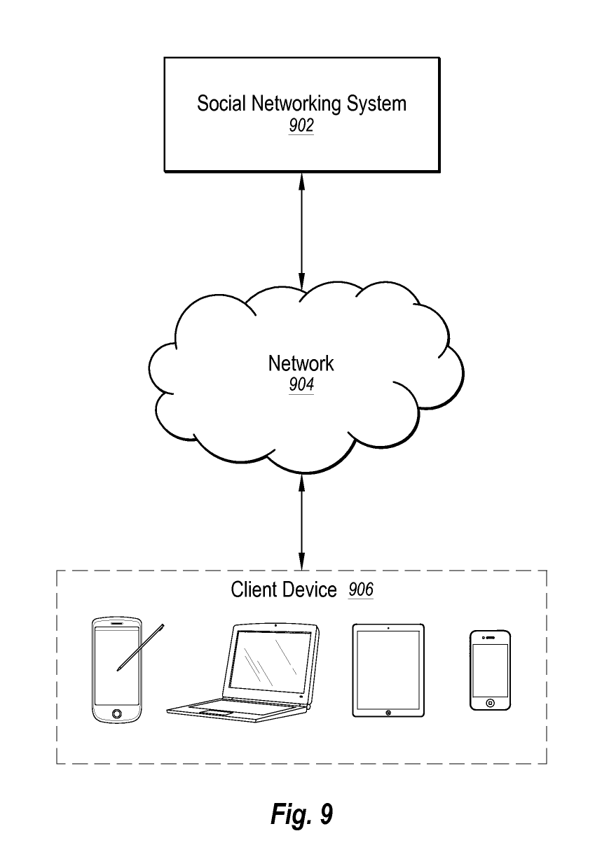

FIG. 9 illustrates an example network environment of a social-networking system. In particular embodiments, a social-networking system 902 may comprise one or more data stores. In particular embodiments, the social-networking system 902 may store a social graph comprising user nodes, concept nodes, and edges between nodes as described earlier. Each user node may comprise one or more data objects corresponding to information associated with or describing a user. Each concept node may comprise one or more data objects corresponding to information associated with a concept. Each edge between a pair of nodes may comprise one or more data objects corresponding to information associated with a relationship between users (or between a user and a concept, or between concepts) corresponding to the pair of nodes.

In particular embodiments, the social-networking system 902 may comprise one or more computing devices (e.g., servers) hosting functionality directed to operation of the social-networking system 902. A user of the social-networking system 902 may access the social-networking system 902 using a client device such as client device 906. In particular embodiments, the client device 906 can interact with the social-networking system 902 through a network 904.

The client device 906 may be a desktop computer, a laptop computer, a tablet computer, a personal digital assistant (PDA), an in- or out-of-car navigation system, a smart phone or other cellular or mobile phone, or a mobile gaming device, other mobile device, or other suitable computing devices. Client device 906 may execute one or more client applications, such as a web browser (e.g., Microsoft Windows Internet Explorer, Mozilla Firefox, Apple Safari, Google Chrome, Opera, etc.) or a native or special-purpose client application (e.g., Facebook for iPhone or iPad, Facebook for Android, etc.), to access and view content over network 904.

Network 904 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 906 may access the social-networking system 902.

While these methods, systems, and user interfaces use both publicly available information as well as information provided by users of the social-networking system, all use of such information is to be explicitly subject to all privacy settings of the involved users and the privacy policy of the social-networking system as a whole.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
associating, using at least one processor, a token with a merchant;
receiving a request associated with the merchant;
identifying the token within the received request;
parsing additional information within the request to obtain a merchant identifier associated with the merchant; and
enabling a gift card service using the merchant identifier.

2. The method of claim 1, wherein the request received from the merchant is a payment authorization request.

3. The method of claim 1, further comprising generating the token to be associated with the merchant.

4. The method of claim 3, wherein the token comprises a monetary value.

5. The method of claim 4, wherein identifying the token within the received payment authorization request comprises identifying the monetary value requested to be authorized by the payment authorization request.

6. The method of claim 4, further comprising providing the monetary value for entry into a merchant system as the payment amount to be authorized.

7. The method of claim 6, further comprising:
issuing a gift card; and
detecting that the gift card has been physically swiped at the merchant system for the amount of the monetary value.

8. The method of claim 7, further comprising sending a request to a third-party with instructions to initiate a gift card transaction with the gift card at the merchant system and using the monetary value.

9. The method of claim 6, further comprising sending a gift card number to the merchant to initiate a gift card transaction for the monetary value.

10. The method of claim 1, wherein parsing the additional information within the payment authorization request to obtain the merchant identifier comprises identifying a merchant identifier number (MID) associated with the merchant.

11. The method of claim 1, further comprising linking the token with a gift card having a unique card number.

12. A method comprising:
maintaining a database identifying a plurality of available merchants for gifting;
associating a token with a merchant not included in the plurality of available merchants for gifting;
receiving a request from the merchant;
identifying the token within the received request;
analyzing additional information within the request to obtain an identifier of the merchant; and
adding the merchant and the obtained identifier to the database identifying the plurality of available merchants for gifting.

13. The method of claim 12, wherein the request received from the merchant is a payment authorization request.

14. The method of claim 12, further comprising receiving a request from a user of a social-networking system to add the merchant to the plurality of available merchants for gifting.

15. The method of claim 14, further comprising generating the token as a monetary value.

16. The method of claim 15, further comprising providing the monetary value for entry into a merchant system associated with the merchant.

17. A method comprising:
determining whether an identifier was found in a database search;
if the identifier is found, associating the identifier with the merchant; and
if the identifier is not found:
requesting the identifier from the merchant;
determining whether the merchant provided the identifier in response to the request;
if the merchant provides the identifier, associating the identifier with the merchant; and
if the merchant does not provide the identifier, analyzing an unidentified payment authorization request using a fuzzy logic routine to identify merchant name information and merchant location information associated with the merchant.

18. The method of claim 17, further comprising matching the unidentified payment authorization request with the merchant based on the merchant name information and the merchant location information.

19. The method of claim 18, further comprising identifying the identifier within the unidentified payment authorization request.

20. The method of claim 19, further comprising storing a value associated with the merchant on a gift card of a user of a social-networking system.
